(19) United States
(12) Patent Application Publication
(10) Pub. No.: US 2009/0065416 A1
(43) Pub. Date: Mar. 12, 2009

(54) ELASTIC POROUS COLUMN MATERIAL

(75) Inventor: Bernd-Walter Hoffmann, Waldbronn (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/281,790

(22) PCT Filed: Mar. 13, 2006
(86) PCT No.: PCT/EP06/60645

§ 371 Date: Sep. 5, 2008

(51) Int. Cl. B01D 15/10; B01D 15/08; G01N 30/02

(52) U.S. Cl. 210/198.2; 210/510.1; 252/408.1; 428/332

(57) ABSTRACT

A packing composition (110) for inserting into a fluidic device (100), the packing composition (110) comprising a packing material (114) adapted for separating different components of a fluid and an elastic network (115) in which the packing material (114) is embedded.

### BACKGROUND ART

The present invention relates to column material for a fluidic device.

In liquid chromatography, a fluidic analyt may be pumped through a column comprising a material which is capable of separating different components of the fluidic analyt. Such a material, so-called beads which may comprise silica gel, may be filled into a column tube which may be connected to other elements (like a control unit, containers including sample and/or buffers) using fitting elements.

During operation, a flow of sample traverses the column tube filled with the fluid separating material, and due to the physical interaction between the fluid separating material and the different components in the fluidic analyt, a separation of the different components may be achieved. Consequently, the fluid separating material filled in the column tube may be subject of a mechanical force generated by the fluidic analyt pumped from an upstream connection of the column to a downstream connection of the column with a relatively high pressure.

U.S. Pat. No. 5,908,552 discloses a column for capillary chromatographic separations, for example high performance liquid chromatography, including a column bed of packing material arranged in the inner bore of a column.

U.S. Pat. No. 5,858,241 discloses another column for capillary chromatographic separations.

US 2004/0156753 A1 by the same applicant Agilent Technologies discloses a PAEK-based microfluidic device comprising two separate substrates which are bonded together to form channels where gases or liquids may move to accomplish applications of the microfluidic device. Thus, an internal cavity may be formed as a lumen or a channel of the microfluidic device.

U.S. Pat. No. 5,071,610 discloses a composite article having controlled void volume and mean pore size comprising a polytetrafluoroethylene (PTFE) fibril matrix, and insoluble, non-swellable sorptive particles enmeshed in said matrix. The ratio of non-swellable sorptive particles to PTFE is in the range of 40:1 to 1:4 by weight, the composite article has a porosity in the range of 30 to 80 percent void volume and a mean pore size in the range of 0.3 to 5 micrometers, preferably with at least 90 percent of pores having a size less than 3.6 micrometers.

U.S. Pat. No. 5,338,448 discloses that liquid chromatography separation columns can be protected from contamination with particulate and dissolved contaminants by the use of a thin protective pad which removes contaminants from a sample stream prior to separation of the sample on the separation column. The protective pad may be in the form of a guard disk positioned inline or directly contacting the separation column.

### DISCLOSURE

It is an object of the invention to provide an efficient packing material for inserting in a fluidic device. The object is solved by the independent claims. Further embodiments are shown by the dependent claims.

According to an exemplary embodiment of the present invention, a packing composition (for example a multi-component material for liquid chromatography) for inserting into a fluidic device (for example a high-performance liquid chromatography apparatus, HPLC) is provided, the packing composition comprising a packing material (for example beads of a silica gel) adapted for separating different components of a fluid (for example a fluidic analyt pumped through a column tube), and an elastic network (for example a polymeric web for embedding particles of the fluid separating material) in which the packing material is embedded.

According to another exemplary embodiment, a method of manufacturing a packing composition for a fluidic device is provided, the method comprising embedding a packing material adapted for separating different components of a fluid in an (particularly mechanically) elastic network.

According to still another exemplary embodiment, a packing composition (for example a multi-component material for liquid chromatography) for inserting in a fluidic device (for example a high-performance liquid chromatography apparatus, HPLC) is provided, wherein a defined fluid separation property (for example an upper limit for a size of analyt components which are still capable of traversing the packing composition, a distribution of pore sizes of the packing composition, etc.) of the packing material is adjustable by adjusting components (for example particular materials or a material of particular properties like pore dimensions) of the packing composition.

According to yet another exemplary embodiment, a method of manufacturing a packing composition for inserting in a fluidic device is provided, the method comprising adjusting a defined fluid separation property of the packing composition by adjusting components of the packing composition.

According to another exemplary embodiment, a packing material (for example a single-component or a multi-component material for liquid chromatography) for inserting in a fluidic device is provided, wherein the packing material is elastic (for instance reversibly deformable) so as to be capable of absorbing a pressure fluctuation (for instance a pressure peak or a pressure step of 100 bar or more) acting on the packing material (for instance generated by a switch of an operation state of a pumping system for pumping an analyt through the packing material of the fluidic device).

According to still another exemplary embodiment, a frit element for inserting in a fluidic device is provided, the frit element comprising a (for instance flexible or elastic) porous polymeric material.

According to a further exemplary embodiment, a fluidic device (for example a liquid chromatography apparatus like a high-performance liquid chromatography apparatus, HPLC) for separating different components of a fluid is provided, the fluidic device comprising a column tube and a packing composition having the above mentioned features or a packing material having the above mentioned features inserted in at least a part of the column tube.

The term “network” may particularly denote a mixture with particles and plastic. The term “network” may also denote a polymer that is cross-linked. The term “network” may also be substituted by the term “composite” which may also denote any mixtures of plastics and particles.

More generally, when speaking about a polymer, this may include polymer blends, copolymers and cross-linked polymers. For the particles, it is possible to consider porous or non porous metal oxide beads including Al₂O₃ or carbides.

It is also possible to consider surface groups that may aid in uniformly dispersing the particles or even having a reaction of the particle with the polymer to remain in the membrane and not leach out during use. Functional groups which may be attached to beads in order to further improve bonding of the beads to the polymeric web may be, for instance, amino-groups (—NH2), quaternary ammonium-groups (NR4⁺), or carboxylic-groups (COO⁻).

According to one exemplary aspect, a packing material may be provided as a mixture of an elastic network and a packing material having analyt separating properties and being embedded in the elastic network. Thus, a mechanically stable two or multiple component system may be provided which may have elastic properties so as to be capable to absorb or cushion pressure shocks, and which may therefore particularly serve as a frit element in a microfluidic device.

According to a second aspect, such a multi-component packing composition may be used as some kind of construction set or kit which may allow a user to selectively adjust desired fluid separation properties for a particular application by setting different components of such a packing composition. For instance, an effective pore size or a continuous or step like pore size distribution may be adjusted by setting a mixture ratio, the mixture comprising or consisting of an elastic network and fluid separating beads embedded therein. Furthermore, different portions of a liquid chromatography column may be filled with different fluid separating materials or with different fluid separating compositions so as to adjust, in a spatially defined manner, the fluid separation properties of the entire system. For instance, a pre-column and a post-column may be formed with different fluid separation properties. The pre-column may allow for a pre-separation of a fluidic analyt according to a first fluid separating criteria (like a filter function selectively allowing only special components of the fluidic analyt fulfilling a particular condition, like a size condition, to pass the pre-column). The post-column may allow for a post-separation of a fluidic analyt according to a second fluid separating criteria (like a fraction separating function allowing to spatially split different fractions of the fluidic analyt passing the post-column).

According to a third exemplary aspect, a pressure fluctuation absorbing packing material for a liquid chromatography column may be provided being elastic and having a property to, even in the presence of strong pressure fluctuations of some hundred bars (and/or in the presence of high temperatures of 100-250° C.), return to its initial mechanical state it had before the pressure fluctuation. By taking this measure, it may be avoided or suppressed that a strong pressure shockwave plastically deforms material filled in an LC tube. Such an undesired non-reversible plastic deformation, particular compression, of column material would generate a disturbing material free hollow portion within the column tube which may deteriorate the fluid separating capability of the system. By implementing an elastically deformable packing material, for instance a packing composition of fluid separating beads and an embedding polymeric network, such pressure fluctuations may be damped or at least partially absorbed by such an elastic material which may improve the performance of the liquid chromatography device.

According to a fourth exemplary aspect, such a porous polymeric material, for instance being formed as a composition of fluid separating beads and an embedding network, may be used as a frit element which may have elastic properties. Such a frit may be an element to be inserted in a liquid chromatography column as an “interface” between the fluid separating material and connected elements of the liquid chromatography device. Such a frit may be adapted to maintain fluid separating material inside to the column tube even in the presence of a fluid flow tending to remove the separating material from the tube, or particular in the presence of pressure shocks which may strengthen the effect to remove the fluid separating material from an inside of the tube.

Therefore, materials described in this application may be properly suited to be filled in a liquid chromatography device, due to their adjustable elastic and mechanically supporting properties.

According to an exemplary embodiment, a substance is provided comprising a mixture of packing material (which may also be denoted as fluid separation material) for liquid chromatography on the one hand and an appropriate embedding network for enclosing individual particles of such a packing material on the other hand. Using the network, different particles of the packing material may be held in place. When such a material is filled in at least a part of a column tube of a liquid chromatography device, an immobilized section of such material within the column tube can be obtained. Even under the influence of a high pressure and particular high pressure fluctuations, the packing material may be securely prevented from being removed from the column tube during the performance of the liquid chromatography experiment.

Thus, it may be avoided that fluid separation material is washed out of the column tube and/or is separated from inner walls of the column tube. Consequently, the elastic network may form a stable and robust particle connecting matrix which additionally may allow for the absorption of pressure shocks.

It may be possible that the beads embedded in the network are inserted in a column tube over the entire extension of the column bead, or only at one or more certain portions along the extension of the column, such as at one or more end portions or at a central portion. Therefore, conventional sintered frits positioned at end portions of a column tube to sandwich packing material therebetween may be dispensable or may be substituted by correspondingly modified fluid separation material.

In other words, a network sticking together column beads at end portions of the column tube may serve as some kind of “microfrit” or may replace conventional frits. Therefore, in the context of liquid chromatography (for instance high performance liquid chromatography, HPLC), the packing material may be provided in such a manner that the beads are embedded in the flexible network, particularly without being glued to the network. Thus, a matrix may be provided for receiving beads in empty portions of the matrix. Additionally, an elastic property of the entire composition may be obtained. This may improve the quality of such filling material and may stabilize the performance of the liquid chromatography system since any deterioration of the functionality caused by an irreversible deformation of the filling material may be prevented due to the elastic property. Therefore, such a column material may be used for separating different components of an analyt in a qualitative and/or quantitative manner, in order to identify different components of such a fluid. Such a packing material may separate the different components based on different affinities of the individual substances with respect to the column material. Therefore, the analyt may be pumped (even with a relative high pressure of some hundred bar or with relative high pressure differences of some hundred bar) through the packing material.

Particularly with small dimensions of columns (for instance an inner diameter of a column tube capillary of 200 μm to 300 μm or less), it may be difficult to manufacture and mount very small frits. Particularly, in such a scenario it may be more appropriate to insert material in a column and to form the polymeric network embedding the beads in an operation state in which the materials are filled in the column tube. In contrast to sintered frits, such a composition material may be highly flexible and may thus promote a continuous and homogeneous filling of a column tube with fluid separation material over the entire lifetime of a liquid chromatography column.

According to an exemplary embodiment, a porous elastic polymer frit may be provided comprising polymer chains between which beads are embedded, for instance in a frit region of a column tube. For instance, beads may be woven with polymeric chains. This may allow to adjust a porosity with the defined pore size distribution, which may be defined by the porosity of the beads. The entire material may have elastic properties. By varying the bead properties (for instance along an extension of the column filling), a pre-column and a main-column can be formed separately, each of the column portions having different fluid separation properties. For instance by varying the bead properties along the extension of the column (like using two bead types with different separation properties), a column tube with sophisticated properties may be obtained.

By connecting beads using polymeric chains (for instance porous polymeric materials), it may be possible to generate porous polymeric frits, in which the porosity of the beads may determine the degree of the porosity of the entire material. Furthermore, the material of polymeric chains embedding beads may fix a column bead in a spatial manner. This unusual kind of connecting beads may result in a frit having a high mechanical stability, and simultaneously flexible elastic properties. This may be advantageous in the presence of pressure fluctuations or pressure pulses which may occur particularly when switching between different operation modes of a liquid chromatography device. For instance when switching between a rinse mode in which a rinse fluid is pumped through the column, and a measurement mode in which an analyt to be analyzed is pumped through the column, such pulses or pressure fluctuations of some hundred bar may occur.

The elastic frits according to an exemplary embodiment may be capable of absorbing mechanical energy of such pressure fluctuations or to balance or adjust such fluctuations.

In the packing composition according to an exemplary embodiment, the contribution of the beads may be larger, particularly significantly larger than the contribution of the polymeric network. For instance, a weight ratio between beads and network may be 5:1, 10:1 or 99:1.

In an HPLC, a pump may convey a sample through a tube which may then be supplied to a physical measurement instrument (like an optical spectrometer) for further analysis. Such a pump may generate a high pressure acting on the sample when the sample is pumped through the column. Such a sample may be a single component or may be a mixture of up to one hundred or more components. Within the column, fluid separating material may be present which may be capable of separating the different components of the sample. According to an exemplary embodiment, the packing composition may serve as a high pressure fitting in the column and may be located between fitting ends of the column. Such fitting ends may be in accordance with high pressure requirements and may be capable of being operated with a pressure of 200 bar to 1000 bar. The column end portion material or frit which may be provided according to an exemplary embodiment may serve as an intermediate piece between the fitting ends and conventional fluid separation material embedded there between. Such a polymeric elastic frit may have pores and may thus be permeable for the sample. In addition, such a polymeric elastic frit may damp pressure pulses and may thus serve as a mechanical protection and a stabilizing agent for the remaining column filling material.

In the event of a switch of the flow in the path from the pump to the column, pressure fluctuations may occur. Such a temporal “pressure short circuit” may last, for instance, 30 seconds or more. In such an event, the elastic polymeric frit according to an exemplary embodiment may prevent that the column material is washed out of the column. This may allow to reuse the sample a plurality of times, for instance 3000 times. It may particularly be avoided that a hollow “dead volume” is generated by a non-reversible compression of the column filling resulting from a pressure pulse, since the elastic polymeric frit or column material may damp such pressure pulses.

The packing composition according to an exemplary embodiment may allow for a permanent connection of particles in order to achieve a desired particle size or size distribution. A network made of a plastics material (for instance an organic connection like caoutchouc, rubber, etc.) can be foreseen in which beads or other fluid separation material may be introduced. The size of the beads and the porosity of the beads may determine the passage properties. Such a material may serve as a basis for an inlet frit and/or an outlet frit. Therefore, it may be prevented that column material is washed out of the column tube. For instance, a silica embedded polymeric frit may be used.

In order to connect the fluid separating material with the network, it may be possible to bring porous Teflon to a melting temperature so that the porous Teflon may penetrate into the beads or between the beads. After subsequent cooling, a network of polymeric material with the beads being embedded therein may be provided. However, it may be possible that rigid connections between the beads and the polymeric network are prevented and that connections between the beads and the polymeric network remain free of chemical bondings. This may promote the elastic properties of the composite.

In order to embed the fluid separating material, for instance beads, in an embedding matrix, the beads may be mixed with a material forming such a matrix. Then, the mixture may be heated and/or may be pressed so that the beads diffuse in the network forming material. After cooling the mixture, the packing composition may be readily manufactured.

The polymeric matrix may have the function to embed the beads so as to form a frit-like element. Furthermore, due to the elasticity of such a polymeric matrix, it may be capable of damping pressure beads and to release the pressure with a time delay.

The term “polymer” may particularly denote any chemical being a sum of monomeric building blocks. However, the network matrix does not necessarily have to be made from polymeric material, but can also be made from a non-polymeric material. It should be porous and should have a sufficiently high value of the elasticity module. It should be compatible with the requirements of a HPLC and may be free of interactions with the beads or may interact sufficiently weak with the beads. It should be compatible with solvents, particularly with solvents used in HPLC devices (like water, polar or non-polar solvents). For instance, it may be advantageous that the embedding matrix is compatible for use with any organic solvents like octane, or with water.

As a beads material, any basic material may be used which may be chemically modified in order to adjust the material properties. 80 to 95% of the material of the packing composition may be formed by the beads, and at least a part of the rest by the embedding matrix.

Different bead materials may be used for a frit formed as a bead-matrix composition on the one hand, and for the central portion of the column tube on the other hand.

By using different bead materials, a pre-separation and a main-separation may be performed and functionally distinguished. For instance, when a blood sample is transported through the column beads, blood serum may be filtered out by a pre-filter (which may then be washed and used for another measurement), and the remaining part of the sample may be analyzed in the main filter.

According to an exemplary embodiment, a porous end portion for a HPLC separation column may be provided for preventing a backflow under normal operation conditions. The separation capability may be maintained. Simultaneously, the lifetime of a column being operated with such packing material may be increased. The packing material may be provided as a powder-like multi-component (particularly two-component) composition.

During the operation of a HPLC, a sample to be analyzed is injected into the column for defined periods of time. For this purpose, a sample loop is firstly disconnected from a hydraulic path of the system, in order to introduce the sample via a sample needle (so-called “bypass mode”). Then, the sample loop filled with the sample may be connected to the hydraulic path and may be transported into the column using a pump (so-called “mainpass mode”). During the switching process to the mainpass mode, the sample loop containing the sample (kept at atmosphere pressure) should be brought to a (significantly larger) system pressure level. This may cause a pressure dip which acts on the column as a pressure pulse. This pressure pulse may have, in dependence of the system pressure, the effect that a short partial reflow is generated in the column, for pressure equilibration.

Such a reflow in the column may be prevented or suppressed according to an exemplary embodiment. This may improve the separation performance of the column and may increase the lifetime (particularly the number of injections) before the column has to be substituted.

These or other benefits may be achieved using a connection portion made of a porous plastics. Such a porous plastics may have special properties, which may physically absorb the pulse energy during the injection procedure and may shield the pressure pulse from influencing the filling of the column tube. Such a porous plastics material may have the property to act itself as a fluid separation material in a composite state with an actual fluid separating material. In this context, such a porous plastics material may have filter properties. The porosity of the connection element may be selectively adjusted. Furthermore, such a connection element or frit may be substituted by another identical or different connection element. For instance, PTFE may be an appropriate material which may be used for such a connection element.

Next, further exemplary embodiments of the invention will be described.

In the following, further exemplary embodiments of the packing composition will be explained. However, these embodiments also apply for the methods of manufacturing the packing compositions, for the packing material, for the frit element and for the fluidic device.

The packing material of the packing composition may comprise (for instance essentially spherical) beads being at least partially permeable for the fluid. In other words, the beads may be configured in such a manner that fluid may pass through the beads. For this purpose, microchannels or pores may be provided in the beads, the microchannels or pores having a size which allows the fluid to pass through these (micro- or nano-)cavities.

At least some of the beads may comprise one or more pores being permeable for the fluid. Such pores or (micro- or nano-) channels may allow to be dimensioned in order to separate fluid having particles of a predetermined dimension.

The beads may have a size in the range of essentially 1 μm to essentially 50 μm. However, smaller or larger sizes are possible. The pores of the beads may have a size in the range of essentially 0.02 μm to essentially 0.03 μm. However, larger or smaller sizes are possible.

The packing material may comprise one of the group consisting of polystyrene, zeolite, polyvinylalcohol, polytetrafluorethylene, glass, polymeric powder, silicon dioxide, and silica gel. However, any packing material can be used which has material properties allowing an analyt passing through this material to be separated into different components, for instance due to different kinds of interactions or affinities between the packing material and fractions of the analyt.

The elastic network may comprise at least one material of the group consisting of an organic material, a polymer, a rubber, caoutchouc, polytetrafluorethylene, expanded polypropylene, an elastomer or the like. Such an elastic network may have the elastic properties which enable a flexible use of such a network, in order to damp pressure pulses in the order of magnitude of some hundred bar. Advantageously, such an elastic network has, in a broad range of pressures, characteristics which fulfill in proper approximation Hook's law.

The elastic network may comprise an inorganic material like silica gel, graphite or porous carbon. Using such an inorganic material for the network may allow for a very efficient damping of pressure energy. Inorganic materials may be designed to have a desired value of the elasticity, may allow for an efficient sealing and a sufficient pressure stability. The elastic network is a protection against pressure fluctuations. The fluid separation material woven in the elastic network primarily serves for controlling the porosity, but may assist or promote the damping.

It is also possible to provide the network as a mesh structure of wires. In empty spaces between interconnected, woven or networked wires, the actual fluid separation material may be located.

A weight percentage of the elastic network may be smaller, preferably significantly smaller, than a weight percentage of the packing material. For instance, 90% or more of the weight of the packing composition may be contributed by the packing material, and at least a part of the rest may be contributed by the elastic network.

Particularly, a weight percentage of the elastic network may be in a range between 5% and 20%. With such a weight percentage, a proper fluid separation property may be combined with proper elastic characteristics.

More particularly, the weight percentage of the packing material may be in the range between 80% and 95%.

The packing composition may be adapted to maintain elastic properties under the influence of a pressure in a range between 200 bar and 1000 bar. Thus, the packing composition may be suitable for use with high pressure liquid chromatography applications.

The packing composition may be adapted to form pores between the elastic network and the packing material. Therefore, the packing composition may have two kind of pores, namely the pores of the packing material itself and pores or cavities formed between the elastic network and the packing material. Therefore, the fluid separating performance of the packing composition made of multiple materials may be improved or refined.

The defined fluid separation property of the packing material may be adjustable by adjusting a porosity of the packing composition. The porosity of the packing composition may be defined by dimensions, a density and/or a distribution of internal pores of beads included in such a packing material. Using different pore sizes in different (spatial) portions of the packing composition arranged along an extension of a column tube of a liquid chromatography device, sophisticated fluid separation features may be obtained.

The defined fluid separation property of the packing material may further be adjustable by adjusting different materials of the packing composition. For instance, different spatial portions or sections along an extension of a liquid chromatography column may be filled with different packing materials so as to achieve special fluid separation capabilities of the multi-component packing composition. The different materials of the packing composition may have different fluid separation selectivity properties. For instance, a pre-filter and a main filter may be combined. Two or more different beads materials may be combined, for example polar and non-polar beads for separating ionic and non-ionic components.

Particularly, the defined porosity of the packing material may be adjusted by providing different materials of the packing composition, wherein the different materials may have different pore sizes.

The packing composition may comprise a support member for supporting the elastic network in which the packing material is embedded. Such a rigid support member may be provided as a limiting wall for the beads embedded in the network so as to prevent the composition from being washed out of a column tube under the influence of a fluid pumped with high pressure through the column. In flow direction, the support element may comprise or consist of a web or the like allowing the fluid to flow through the support element essentially without a pressure drop. Essentially perpendicular to flow direction, the support element may comprise or consist of a sleeve or the like preventing the fluid to flow along another path than the flow direction. By taking such a measure, stability may be improved, and removal of the beads embedded in the network from a column may be prevented by the support member at least partially surrounding the packing composition. Such a support member may be implemented advantageously in a high pressure environment.

The support member may serve for supporting the packing composition by a sleeve structure or the like. It may provide longitudinal and/or axial support, with respect to a flowing direction of fluid being guided through a fluidic device.

The support member may be adapted for covering, in an essentially planar manner, one of the group consisting of a top side, a bottom side, and a top side and a bottom side of the elastic network in which the packing material is embedded. In other words, in fluid flow direction, the support member may be located at an upper side and/or at a lower side of the composition.

The support member may be permeable for fluid and may be impermeable for the elastic network in which the packing material is embedded. This may allow to transport a liquid sample or a rinse solution through the packing material, but prevent the packing material to be washed out.

The support member may comprise at least one of the group consisting of a screen, a web, a cave, a sinter body, and a filter. For instance, such a screen may comprise openings in the order of magnitude of several micrometers, like 0.5 μm or more. For instance, such a screen may have a plurality of different mesh sizes.

The support member may be adapted for covering the elastic network in which the packing material is embedded in an essentially circumferential manner. Thus, the support member may provide lateral mechanical support.

The support member may be impermeable for fluid and may be impermeable for the elastic network in which the packing material is embedded. Thus, both fluid and packing material may be incapable to pass through the circumferential support. For example, the support member may comprise at least one of the group consisting of a sleeve, a ring, and a tube.

The support member may comprise at least one of the group consisting of plastics (for example PEEK or PTFE) or stainless steel.

The support member may comprise a planar cover element for covering one of the group consisting of a top side, a bottom side, and a top side and a bottom side of the elastic network in which the packing material is embedded, and may comprise a circumferential cover element for covering the elastic network in which the packing material is embedded in an essentially circumferential manner, wherein the planar cover element is connected to the circumferential cover element. The planar cover element and the circumferential cover element may be integrally formed, but may be made of different materials.

In the following, further exemplary embodiments of the method of manufacturing a packing composition for a fluidic device will be described. However, these embodiments also apply for the packing compositions, for the packing material, for the frit element and for the fluidic device.

The method may comprise embedding the packing material in the elastic network by heating a mixture of the packing material and the material forming the elastic network. After cooling such a mixture, the packing material, for instance beads, may be embedded between chains or in cavities of the elastic network, for instance in a polymeric network.

Additionally or alternatively, the method may comprise embedding the packing material in the elastic network by applying a pressure to a mixture of the packing material and a material forming the elastic network. Thus, instead of a purely pressure induced manufacture, a purely temperature induced manufacture, or a combined pressure induced and temperature induced manufacture of the packing composition may be performed.

Next, further exemplary embodiments of the fluidic device for separating different components of a fluid will be explained. However, these embodiments also apply for the packing compositions, for the methods of manufacturing a packing composition, for the packing material and for the frit element.

The column tube of the fluidic device may comprise a first portion adapted to be coupled to a first fitting element adapted for fitting the column tube to another element (for example upstream) within a fluid path, wherein the packing composition or the packing material may be inserted into the first portion. Such “another element” may for instance be a liquid chromatography control apparatus and/or containers including sample, fluid, etc. Particularly at the downstream end of the column tube, that is to say the end portion of the column tube at which the analyt to be separated leaves the column tube, it may be appropriate to provide the mixture of beads and matrix to avoid washing out of the packing material from the column beads. However, additionally or alternatively, the other end portion of the column tube (that is to say the upstream end portion) may be provided with the packing composition to improve stability.

The column tube may comprise a second portion adapted to be coupled to a second fitting element adapted for fitting the column tube to another element (for example downstream) within the fluid path, wherein the packing composition or the packing material may be inserted into the second portion. As already mentioned above, one or both of the end portions of the column tube adjacent to the two fitting elements may be provided with the packing composition. A portion between these end portions may or may not be filled with the packing composition.

The column tube may comprise a third portion located in a central part of the column tube, wherein the third portion may be free of the packing composition or the packing material. This third portion may also be denoted as an intermediate portion between two end portions and may either be free of any material or may be filled with beads which are not embedded in a network. Therefore, a packing material adapted for separating different components of a fluid and being free of the network may be inserted into the third portion. The fluidic device may comprise a further packing material adapted for separating different components of a fluid and being free of the elastic network inserted into the third portion. Alternatively, the third portion may be filled as well with the packing composition or the packing material.

The column tube may have an inner diameter of less than or equal to 300 μm. Particular at such small diameters, it may be advantageous to substitute conventional frits by the networked column beads, since the production of small dimensioned frits may be costly and difficult.

The packing composition may also be inserted in the entire column tube, for instance when a pressure stable or pressure resistant device is desired, or when a particular robust arrangement is desirable.

The fluidic device may have an essentially cylindrical shape. However, in contrast to this, any other geometrical configuration of the fluidic device is possible, for instance a tube-like device or a device having a polygonal cross-sectional shape (for instance triangular, rectangular or the like). It is also possible to use, instead of a tubular shape, a fluidic device with a truncated conical shape or with an essentially frustum shape. The streaming direction of sample to be guided through such a fluidic device with a truncated conical shape may start from a starting portion with a high cross-sectional surface to an end portion with a small cross-sectional surface.

The fluidic device may comprise a first essentially planar member and may comprise a second essentially planar member, wherein, when the first essentially planar member is coupled to the second essentially planar member, the column tube may be formed using at least one recess formed in the first essentially planar member and/or using at least one recess formed in the second essentially planar member. For instance, a configuration which is shaped similar like a “credit card” with a longitudinally extending channel may be provided.

Such a configuration may be shaped similar as in FIG. 6A, FIG. 6B and corresponding description of US 2004/0156753 A1. FIG. 6A, FIG. 6B and the corresponding description of US 2004/0156753 A1 are explicitly incorporated in the disclosure of this application.

It may be particularly advantageous to fill the cavity of such a configuration with a porous polymeric frit according to an exemplary embodiment, since small dimensioned tubes are not easily compatible with a conventional sintered frit.

The fluidic device may be adapted to analyze at least one physical, chemical, or biological parameter of at least one compound of the fluid. The term “physical parameter” may particularly denote a size or a temperature of the fluid. The term “chemical parameter” may particularly denote a concentration of a fraction of the analyt, an affinity parameter, or the like. The term “biological parameter” may particularly denote a concentration of a protein, a gene or the like in a biochemical solution, a biological activity of a component, etc.

The fluidic device may be adapted as at least one of a sensor device, a test device for testing a device under test or a substance, a device for chemical, biological and/or pharmaceutical analysis, a capillary electrophoresis device, a liquid chromatography device, a gas chromatography device, an electronic measurement device, and a mass spectroscopy device. Particularly, the fluidic device may be a high performance liquid chromatography device (HPLC) in which different fractions of an analyt may be separated and investigated.

The fluidic device may also be a reaction detection device. The term “reaction detection device” may particularly denote an apparatus allowing to detect a (chemical) reaction. For this purpose, the fluidic device may be provided with a probe which, upon a chemical reaction (which may be initiated using room temperature energy or irradiation with electromagnetic radiation) with a sample guided through the fluidic device, effects a change of a detectable property (for instance a change in color) which may then be detected using a UV—detector.

The fluidic device may be adapted as a microfluidic device. The term “microfluidic device” may particularly denote a fluidic device as described herein which allows to convey fluid through micropores, that is pores having a dimension in the order of magnitude of micrometers or less.

The fluidic device may comprise a further packing composition having the above-mentioned features or a further packing material having the above-mentioned features inserted in at least a part of the column tube, wherein the further packing composition or the further packing material may have different fluid separation properties as compared to the packing composition or the packing material. Therefore, different portions of the fluidic device may be filled with different materials having different fluid separation properties.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 to FIG. 4 illustrate fluidic devices according to exemplary embodiments.

FIG. 5 illustrates a measurement system according to an exemplary embodiment.

FIG. 6 shows a diagram illustrating pressure conditions during an operation of the measurement system of FIG. 5.

FIG. 7 to FIG. 9 schematically illustrates packing compositions according to exemplary embodiments.

The illustration in the drawing is schematically.

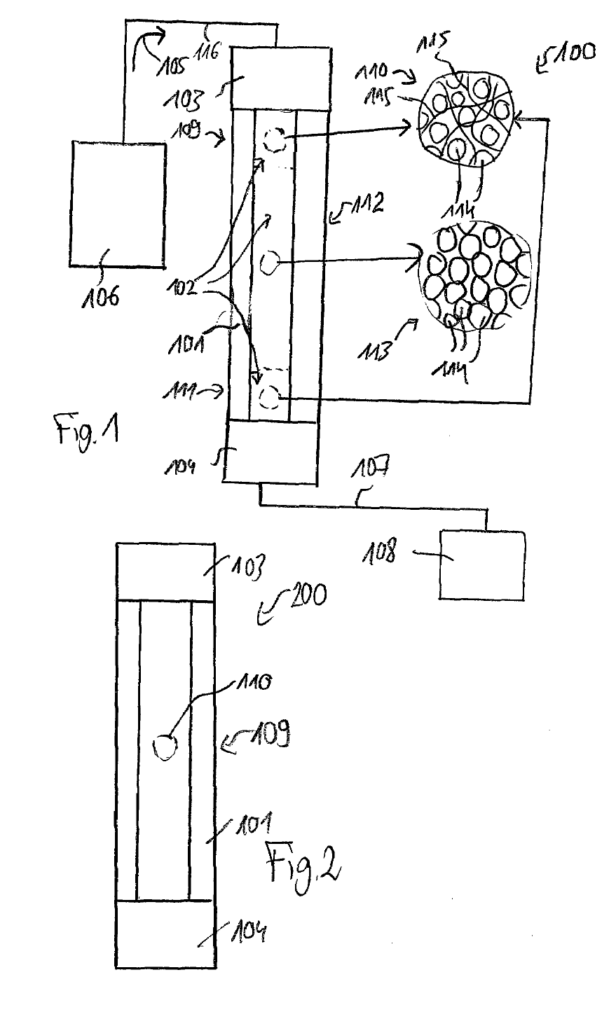

In the following, referring to FIG. 1, a fluidic device 100 according to an exemplary embodiment will be described.

The fluidic device 100 is adapted as a system for carrying out liquid chromatography investigations. The fluidic device 100 for separating different components of a fluid which can be pumped through the apparatus 100 comprises a column tube 101 which is shaped as a hollow cylinder. Within this cylinder, a tubular reception is defined which is filled with a packing composition 102.

The fluidic device 100 does not comprise conventional sintered frits. In contrast to this, a specially designed packing composition 110 is used as a porous polymeric frit element.

The packing composition 110 comprises a packing material 114 adapted for separating different components of a fluid, and an elastic network 115 in which the packing material 114 is embedded. This packing composition 110 serves as a frit-like substitution and is provided between end portions 109, 111 of the column tube 101 on the one hand and of a first fitting element 103 provided upstream the column tube 101 and a second fitting element 104 located downstream of the column tube 101 on the other hand. A flowing direction of the fluid which is separated using the fluidic device 100 is denoted with reference numeral 105.

A fluid separation control unit 106 is provided which pumps fluid under pressure of, for instance, 100 bar through a connection tube 116 and from there through the fitting element 103 into the column tube 101. After having left the column tube 101 through the second fitting element 104, a second tube or pipe 107 transports the separated analyt to a container and analysis unit 108. The container and analysis unit 108 includes cavities or containers for receiving the different components of the fluid, and may also fulfill computational functions related to the analysis of the separated components.

The column tube 101 comprises a first end portion 109 which is coupled to the first fitting element 103 for fitting the column tube 101 to the control unit 106 within the fluid path 105. A first packing composition 110 is inserted into the first end portion 109. An enlarged schematic view of the packing composition 110 is shown in FIG. 1.

Furthermore, the column tube 101 comprises a second end portion 111 coupled to the second fitting element 104 and adapted for fitting the column tube 101 to the container and analysis unit 108. The first packing composition 110 is inserted also in the second end portion 111.

Beyond this, the column tube 101 comprises a third intermediate portion 112 located in a central part of the column tube 101 between the first portion 109 and the second portion 111. The third portion 112 comprises a further packing composition 113 which differs from the packing composition 110. The further packing composition 113 is shown in another detailed view of FIG. 1.

Thus, only in a part 109, 111 of the column tube 101, the first packing composition 110 is inserted, and the remaining part 112 of the column tube 101 is filled with the second composition 113.

In the following, the first packing composition 110 will be described in more detail.

The first packing composition 110 comprises beads of a silica powder as a packing material or as a fluid separation material for separating different components of the fluid. The packing material is provided in the form of beads 114. Furthermore, a polymeric network 115 is provided between adjacent beads 114, so as to interconnect or embed adjacent beads 114 within the network 115. The beads 114 are intrinsically permeable for the fluid to be analyzed and comprise pores. The polymeric network 115 is composed of particles which form chains or a kind of web in which the beads 114 are embedded.

In contrast to this, the second packing material 113 is solely adapted for separating different components of the fluid and is free of the polymeric network 115. Therefore, the second packing composition 113 consists of the beads 114 which are arranged directly next to one another without being embedded in a network 115.

Since the first packing composition 110 provides fixed and unremovable “frit-like” flexible or elastic end portions of the inner tube fluidic device 100, even when an analyt is pumped with a high pressure through the column tube 101, the first packing composition 110 and the sandwiched second packing material 113 are prevented from being washed out of the column tube 101.

When a pressure pulse is generated as a mechanical force compressing the filling of the tube 101, the elastic, damping and absorbing properties of the frit-like members 110 may at least partially absorb this mechanical pressure and may prevent a filling of the tube 101 from being irreversibly compressed or crushed. Therefore, it may be avoided that any hollow space is formed in the tubular recess of the tube 101.

Therefore, the packing composition 110 forms an elastic polymeric frit and contributes to the fluid separation capability of the entire system.

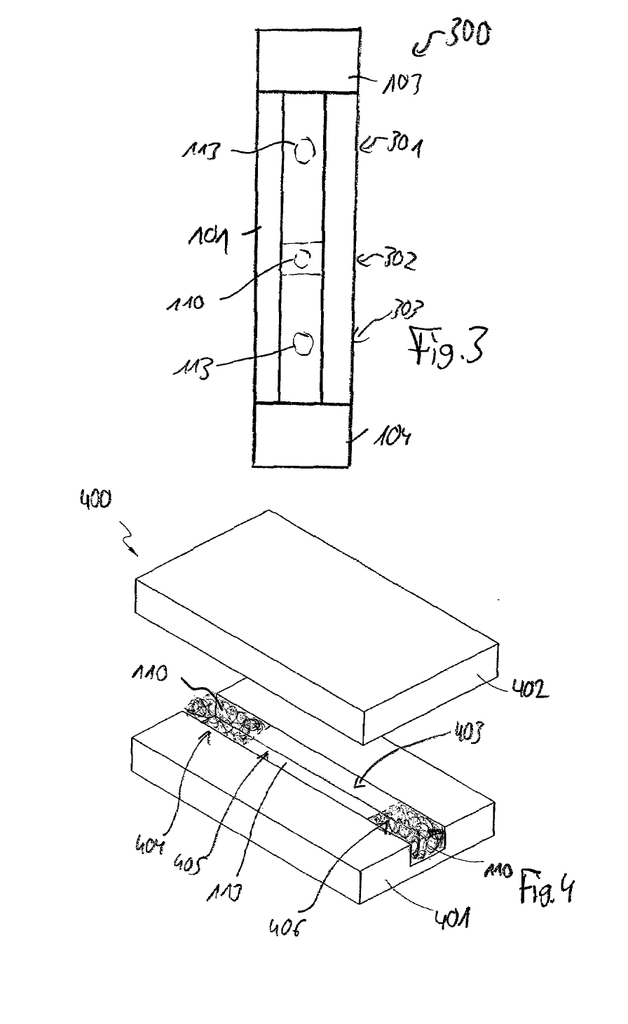

In the following, referring to FIG. 2, a fluidic device 200 according to an exemplary embodiment will be described.

The fluidic device 200 differs from the fluidic device 100 in that the column tube 101 is provided as a single portion 109 which is filled with the first packing composition 110 described above referring to FIG. 1. In other words, along the entire extension of the column tube 101 of FIG. 2, the same fluid separation material is provided, namely a mixture of porous column beads 114 interconnected via polymeric chains of the network 115 so as to form a stable and flexible matrix.

In the following, referring to FIG. 3, a fluidic device 300 according to an exemplary embodiment will be described.

As in the case of FIG. 1, the column tube 101 is divided into three portions, namely a first portion 301 next to the fitting element 103, a second central portion 302 and a third portion 303 located between the second portion 302 and the second fitting element 104. In contrast to FIG. 1, in the scenario of FIG. 3 only the central portion 302 is filled with the column beads 114 which are connected via the polymeric network 115 to one another. In contrast to this, the first portion 301 and the third portion 303 are filled with pure column beads 114 without any connection to one another.

It may be sufficient for particular applications that only such a central portion 302 is filled with the column beads 114 connected to one another by the polymeric web 115.

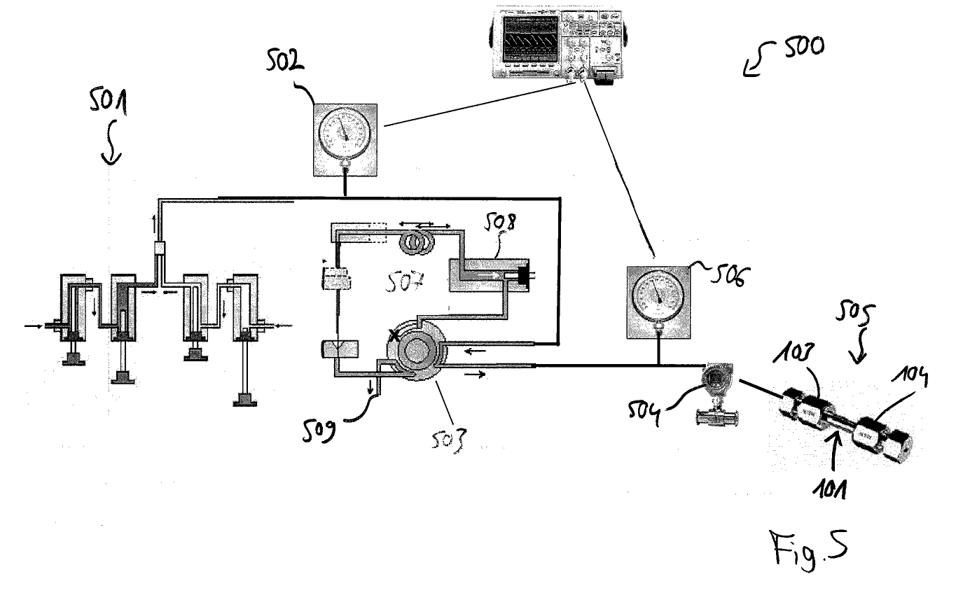

In the following, referring to FIG. 4, a microfluidic device 400 according to an exemplary embodiment will be described.

The microfluidic device 400 comprises a first essentially planar member 401 and a second essentially planar member 402. In an operation state in which the first essentially planar member 401 is coupled to the second essentially planar member 402 (for instance using a polymeric glue), a column tube is formed using the recess 403 which is formed in the first essentially planar member 401 and using the planar surface of the second essentially planar member 402. The recess 403 forms, when the members 401 and 402 are connected to one another, a channel-like structure which has a function similar to the inner bore of the column tube 101 of FIG. 1 to FIG. 3.

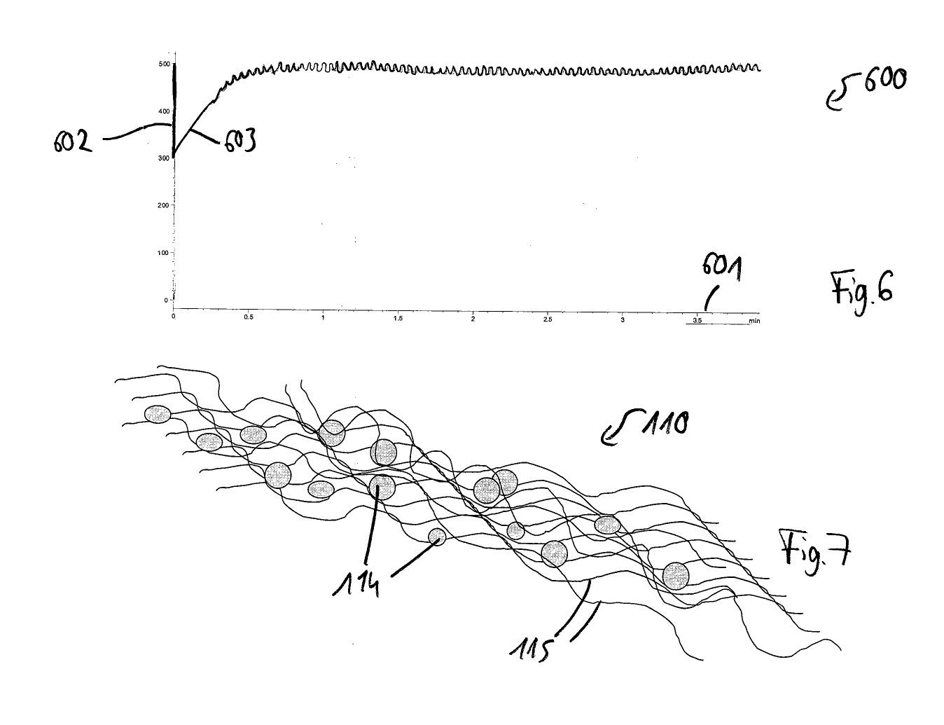

The microfluidic device 400 can be used in a similar manner as described in FIG. 6A, 6B and corresponding description of US 2004/0156753 A1.

FIG. 4 illustrates a patterned PAEK (polyaryl-ether-ketone) substrate 401 having the internal cavity 403 and the other flat substrate 402 that can be bonded with the patterned PAEK substrate 401 to form the microfluidic device 400. The flat substrate 402 can be formed by any solvent resistant material, including, but not limited to, PAEK or glass. The patterned PAEK substrate 401 can be formed using any fabrication technique, including embossing, laser ablation, injection molding, etc. It should further be understood that the microfluidic device 400 can include multiple channels 403, and each channel 403 can include a packing composition with a fluid separation material embedded in a network connecting the components of the fluid separation material to one another and to walls defined by the channel 403.

As shown in FIG. 4, the channel 403 is divided into three portions, namely a first portion 404 filled with a first packing composition 110 as defined above, a second central portion 405 filled with the second composition 113 as defined above and a third portion 406 filled with the first packing composition 110 as defined above.

In order to manufacture the microfluidic device 400, column beads may be inserted into the entire channel 403. Then, material as a basis for a polymeric network 115 may be added selectively to the first portion 404 and to the third portion 406, and the formation of a web-like structure may be initiated by applying heat and/or pressure. Therefore, at the first and third portions 404,406, a connection between individual column beads 114 and an embedding network 115 in the channel 403 may be formed, whereas in the central portion 405, the column beads remain without any embedding polymeric network.

When fluid is inserted for instance at the first portion 404 and is separated by the function of the fluid separation material provided within the entire channel 403, the different fluid components are separated at the second end portion 406. Furthermore, since the end portions 404, 406 may be mechanically pressed against the walls and against the abutting material, it may be avoided that the column beads 114 are washed out of the channel 403 by a fluid pumped through the channel 403.

In the following, referring to FIG. 5, a measurement system 500 according to an exemplary embodiment will be described.

The measurement system 500 comprises a pump portion 501 including a plurality of pumps for generating a pressure to pump a fluid through the apparatus 500. A fast pressure sensor 502 may measure the pressure generated by the pump system 501.

For instance, the pump system 501 may generate a pressure of 500 bar in order to pump 1 ml per minute through the apparatus 500, wherein a 30%:70% mixture of water and AcN may be pumped through the system. This may provide for an isocratic, dynamic blend.

A fluid which is pumped through a valve 503 (in bypass) may be supplied, via a flow meter 504 to a liquid chromatography separation column 505. Again, the pressure at the position of the flow meter 504 can be measured by a pressure sensor 506.

The valve 503 can be brought in an operation state in which fluid from the pump 501 is pumped through the LC device 505. In another operation mode, sample may be pumped through a sampling unit 507 and a metering device 508 via the valve 503 through the LC device 505. For this purpose, the operation mode of the 6 port valve 503 has to be adjusted accordingly. It is also possible to convey waste generated during the measurement to a waste container 509.

It can be easily understood from the configuration shown in FIG. 5 that during the operation of the system, switching between a high pressure mode and a lower pressure mode may occur which may generate a pressure pulse at the position of the packing composition filled in the tube 101 of the LC device 505. Due to the elastic property of the packing composition 110, such pressure pulses do not destroy or deteriorate the packing composition 110 included in the tube 101.

FIG. 6 shows a diagram 600 illustrating such a pressure pulse.

Along an abscissa 601 of the diagram 600, the time is plotted in minutes. Along an ordinate 602 of the diagram 600, the pressure is plotted in bar. At a point of time t=0 s, the system 500 is switched from one operation mode to another. This results in a pressure jump from essentially 500 bar to essentially 300 bar at a time t=0 s. The pressure curve 603 only slowly recovers to go back to the equilibrium pressure of 500 bar. In such a configuration, in a time interval between essentially 0 min and 0.5 min, a large pressure pulse may act onto the composition material 110 in the LC device 505.

Thus, a severe dip of essentially 30% or more occurs with a slow recovery time of essentially 0.5 min. Thus, in an injection loop, 200 to 300 μl compressible liquid are provided to be increased to 500 bar.

FIG. 7 shows, in more detail, a schematic view of the packing composition 110 including the beads 114 and the polymeric network 115. A silica embedded polymeric frit may be generated based on such a packing composition 110.

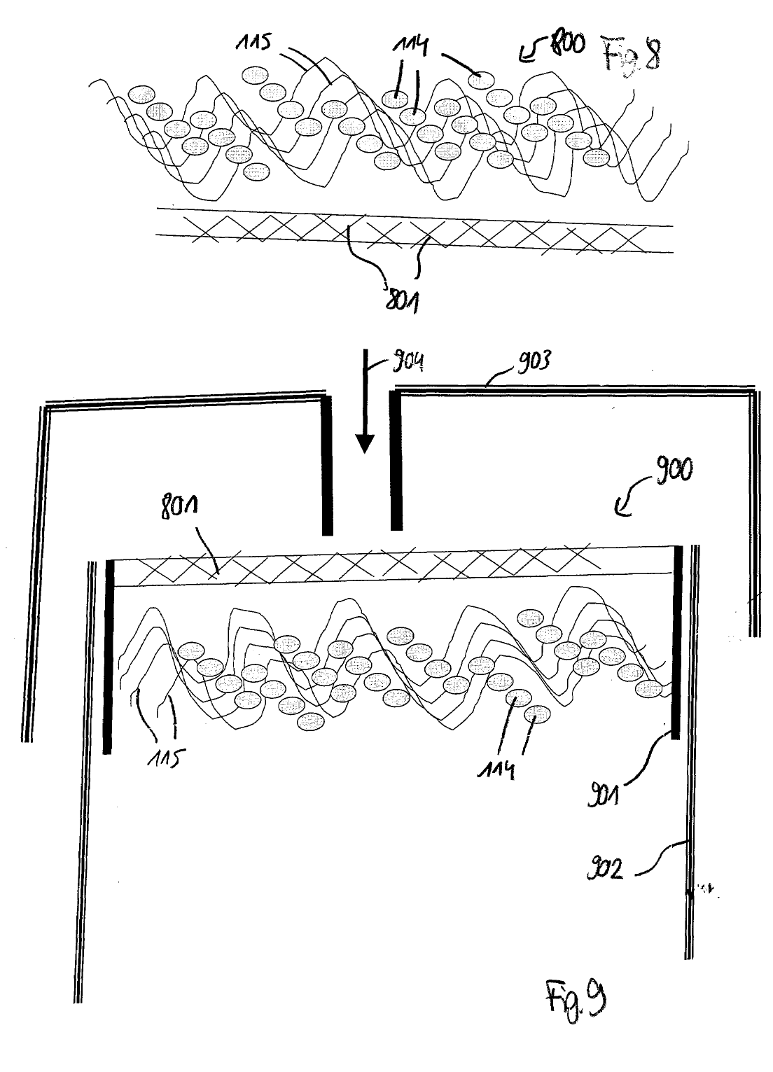

FIG. 8 shows a schematic view of a packing composition 800 according to an exemplary embodiment.

The packing composition 800 includes the beads 114 and the polymeric network 115. Furthermore, a stainless steel screen 801 is provided as a support element downstream the beads 114 and the polymeric network 115, with regard to a fluid flow direction.

The stainless steel screen 801 might also be on top and underneath the porous network 114, 115. This may have the advantage of an easier exchange of consolidated porous network 114, 115 on top of a packed HPLC column. Further advantages may occur during column manufacture.

FIG. 9 shows a schematic view of a packing composition 900 according to an exemplary embodiment, implemented in the context of a fluidic device.

The support member of FIG. 9 comprises a planar stainless steel screen element 801 for covering a top side of the elastic network 115 in which the packing material 114 is embedded. The support member of FIG. 9 further comprises a circumferential cover element 901 for covering the elastic network 115 in which the packing material 114 is embedded in an essentially circumferential manner. The planar cover element 801 is connected to the circumferential cover element 901. The planar cover element 801 and the circumferential cover element 901 are integrally formed, but may be made of different materials. The circumferential cover element 901 is made of a plastics material like PEEK or PTFE. SST may be used to form a metal/metal seal with column tube or column fitting. The column tube is denoted with reference numeral 902, and the column fitting is denoted with reference numeral 903. The fluid flow direction is denoted with reference numeral 904.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. A packing composition for inserting in a fluidic device, the packing composition comprising:
a packing material adapted for separating different components of a fluid; and
an elastic network in which the packing material is embedded.

2. The packing composition of claim 1,
wherein the packing material comprises beads being at least partially permeable for the fluid.

3. The packing composition of claim 2,
wherein at least some of the beads comprise one or more pores being permeable for the fluid.

4. The packing composition of claim 2,
wherein the beads have a size in a range of 1 μm to 50 μm.

5. The packing composition of claim 3,
wherein the pores of the beads have a size in a range of 0.02 μm to 0.03 μm.

6. The packing composition of claim 1,
wherein the packing material comprises one of the group consisting of polystyrene, zeolite, polyvinylalcohol, polytetrafluorethylene, glass, polymeric powder, silicon dioxide, and silica gel.

7. The packing composition of claim 1,
wherein the elastic network comprises at least one material of the group consisting of an organic material, an inorganic material, a polymer, a rubber, caoutchouc, polytetrafluorethylene, expanded polypropylene, porous carbon, carbon clad inorganic oxide materials, Zirconia dioxide0.

8. The packing composition of claim 1,
having a value of the modulus of elasticity in the range between 1500 N/mm² and 3000 N/mm².

9. The packing composition of claim 1, wherein a weight percentage of the elastic network is at least one of:
smaller than a weight percentage of the packing material;
in a range between 5% and 20%;
in a range between 80% and 95%.

10.-11. (canceled)

12. The packing composition of claim 1, comprising at least one of:
the packing composition is adapted to maintain elastic properties under the influence of a pressure in a range between 200 bar and 1000 bar;
the packing composition is adapted to form pores between the elastic network and the packing material;
the packing composition is adapted to form pores between the elastic network and the packing material have a size in a range between 100 Å and 500 Å.

13.-14. (canceled)

15. The packing composition of claim 1,
comprising a support member for supporting the elastic network in which the packing material is embedded.

16. The packing composition of claim 15,
wherein the support member is adapted for covering, in an essentially planar manner, one of the group consisting of a top side, a bottom side, and a top side and a bottom side of the elastic network in which the packing material is embedded.

17. The packing composition of claim 16, comprising at least one of:
the support member is permeable for fluid and is impermeable for the elastic network in which the packing material is embedded;
the support member comprises at least one of the group consisting of a screen, a web, a cave, a sinter body, and a filter.

18. (canceled)

19. The packing composition of claim 15,
wherein the support member is adapted for covering the elastic network in which the packing material is embedded in an essentially circumferential manner.

20. The packing composition of claim 19, comprising at least one of:
the support member is impermeable for fluid and is impermeable for the elastic network in which the packing material is embedded;
the support member comprises at least one of the group consisting of a sleeve, a ring, and a tube.

21. (canceled)

22. The packing composition of claim 15,
wherein the support member comprises at least one of the group consisting of plastics and stainless steel.

23. The packing composition of claim 15,
wherein the support member comprises a planar cover element for covering one of the group consisting of a top side, a bottom side, and a top side and a bottom side of the elastic network in which the packing material is embedded,
wherein the support member comprises a circumferential cover element for covering the elastic network in which the packing material is embedded in an essentially circumferential manner, and
wherein the planar cover element is connected to the circumferential cover element.

24. A method of manufacturing a packing composition for a fluidic device, the method comprising
embedding a packing material adapted for separating different components of a fluid in an elastic network.

25. The method of claim 24, comprising at least one of:
embedding the packing material in the elastic network by heating a mixture of the packing material and a material forming the elastic network;
embedding the packing material in the elastic network by applying a pressure to a mixture of the packing material and a material forming the elastic network.

26. (canceled)

27. A packing composition for inserting in a fluidic device,
wherein a defined fluid separation property of the packing material is adjustable by adjusting components of the packing composition.

28. The packing composition of claim 27, comprising at least one of:
the defined fluid separation property of the packing material is adjustable by adjusting a porosity of the packing composition,
the defined porosity of the packing material is adjustable by providing different materials of the packing composition, the different materials having different pore sizes;
the defined fluid separation Property of the packing material is adjustable by adjusting different materials of the packing composition, and
the different materials of the packing composition are Preferably different fluid separation selectivity properties.

29.-32. (canceled)

33. A packing material for inserting into a fluidic device,
wherein the packing material is elastic so as to be capable of absorbing a pressure fluctuation acting on the packing material.

34.-35. (canceled)

36. A frit element for inserting into a fluidic device,
the frit element comprising a porous polymeric material.

37. A fluidic device for separating different components of a fluid, the fluidic device comprising
a column tube; and
a packing composition of claim 1 or of claim 20 or a packing material of claim 22 inserted in at least a part of the column tube.

38. The fluidic device of claim 37,
wherein the column tube comprises a first portion adapted to be coupled to a first fitting element adapted for fitting the column tube to another element within a fluid path, wherein the packing composition or the packing material is inserted into the first portion.

39. The fluidic device of claim 37,
wherein the column tube comprises a second portion adapted to be coupled to a second fitting element adapted for fitting the column tube to another element within the fluid path, wherein the packing composition or the packing material is inserted into the second portion.

40. The fluidic device of claim 37,
wherein the column tube comprises a third portion located in a central part of the column tube, wherein the third portion is free of the packing composition or the packing material.

41. The fluidic device of claim 40,
comprising a further packing material adapted for separating different components of a fluid and being free of the elastic network, the further packing material being inserted into the third portion.

42.-45. (canceled)

46. The fluidic device of claim 37,
wherein the fluidic device has an essentially planar shape, and the fluidic device comprises a first essentially planar member and comprises a second essentially planar member, wherein, when the first essentially planar member is coupled to the second essentially planar member, the column tube is formed using at least one recess formed in the first essentially planar member and/or using at least one recess formed in the second essentially planar member.

47.-50. (canceled)
